(19) United States
(12) Patent Application Publication
(10) Pub. No.: US 2005/0203650 A1
(43) Pub. Date: Sep. 15, 2005

(54) Administration system

(76) Inventors: Richard Charles O'Leary, Queensland (AU); John Anthony McCrystal, Queensland (AU)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/510,422

(22) PCT Filed: Apr. 7, 2003
(86) PCT No.: PCT/AU03/00416

§ 371 Date: Apr. 21, 2005

(30) Foreign Application Priority Data
Apr. 5, 2002 (AU) PS 1554

(51) Int. Cl. G06F 155/00

(52) U.S. Cl. 700/91

(57) ABSTRACT

An administration system to assist administrators of an event having multiple participants, the system adapted to allow a system administrator to collect, analyse and distribute up to date information about at least one participant, the administration system comprising data collection means including a participant identification means for each participant having at least one identifying feature of the participant recorded thereon and at least one data processing unit adapted to allow recognize and collect information relating to each participant of the event, a data storage means associated with the at least one data collection means to store at least a copy of all information collected by the data collection means, and data distribution means adapted to allow access to the information contained in the data storage means.

### TECHNICAL FIELD

This invention relates to administration and in particular the administration of sporting and recreational events.

### BACKGROUND ART

The administration of sporting fixtures and events, in terms of organisation and reporting to governing bodies can be quite onerous and time consuming.

If, for example, a sporting venue hosts ten team games per day twenty teams are involved and administrators and officials of the day are required to record and report all events, particularly in relation to individual participants, incidents which are claimed to be undesirable, e.g. undue parental interference or attitudes, a large amount of work is involved.

Most organised competitions also require that a record be kept of the statistics of each player in order to determine player eligibility for finals games and details of scorers and the like. This creates an additional administrative burden of requiring that a record of this be kept usually in the form of “sign-on” sheets. In the example above, twenty teams are involved on one day at one ground. The problems of having each player sign on every game creates a problem for officials and also creates a large amount of administrative inefficiency as the administrator must later compile a list of players and the number of games and other statistics played during a season manually.

To date, the administration and reporting of such events is largely a manual process.

Most sporting codes have strict rules relating to the eligibility of players for particular team grades and it is important that administrators are not duped into allowing players to participate in events for which they do not qualify. A secure means of identifying the bona fides of players is essential for this purpose.

It is an object of the present invention to provide an administration system for sporting and recreational events which addresses the aforesaid issues and provides the public with a useful choice.

Further objects and advantages of the present invention will become apparent from the ensuing description which is given by way of example.

### DISCLOSURE OF INVENTION

According to an aspect of the invention, an administration system is provided.

The present invention is intended to assist the administrators in the following areas: reduced paperwork and administration time associated with player and game statistics; enhanced security in order to restrict inappropriate player substitutions; enhanced communication between players, parents and administrators; provide a promotional vehicle to aid sponsors and assist in the promotion of an individual Association.

The system may preferably be used by an upper-level association having subsidiary members. The members may be other associations or individual member clubs consisting of one or more teams and/or individuals.

To achieve these goals the present invention uses three main components:
(i) Data collection,
(ii) A data storage and collation facility,
(iii) Data distribution.

All three components are able to interact with each other and combine to provide a tool that is able to collect information on game day and distribute up-to-date information into the homes of all players and officials while saving administrative time in the process.

The data collection process may comprise in itself two major components. The first is a photographic identification (ID) card which is distributed to all players and officials at the start of each season.

The card provides photographic ID and lists a players club and team as well as other significant information required by each association.

The cards may also feature advertising space for sponsors as well as sponsorship discounts that the card holder can use throughout the year.

Each card identifies the card holder and which is used to identify the card holder and for the collection of information quickly and easily as the bar code allows a large amount of information to be accessed easily.

The second component is a hand held palm and data processing unit. This unit enables the administration officials to collect player lists from each game as well as enter game statistics that may include game scores, point scorers, medical/injury information, start/finish times, umpire reports etc. After collection the data can be sent by email to a central collection facility.

The data collection may be performed in multiple different formats. For example, a list of payers taking part in a given game may be compiled quickly and easily by using the checklist in the hand held unit. Prior to a game commencing, all related data is uploaded from the main data storage and information relating to each of the players accessed or viewed on the data processing unit virtually instantaneously.

The data storage facility may suitably be a database that is controlled and maintained by the association's main administrative staff. The database is used to retain all information that is collected from players, officials, clubs, teams, games and other contacts which the member associations may use. The database can produce reports (that include pictures) for each club, team or school in the association. Complete history of player performance can be accessed from the database. Player registration, emergency contacts, schools, email register, club contact information, news Items can all be stored within the database. The database is also the central point that will collect the information sent from each ground as part of the data collection process.

The information stored in the database may be accessed and/or updated either remotely or through a fixed central access point. The fixed central access point may require the various hand held scanner and data processing units used in the system to be returned to the access point for downloading or the like.

The data distribution system utilises the benefits of the internet and the World Wide Web. From within their own homes, players, officials and the general public can login to the secure website and find out the latest game scores, view the draw, view current ladders, view pictures of club and team mates, find out latest news items. Everyone who receives an ID card also has log in access to the website and can view areas such as “My Team”, “My Club”. The website also provides public access where interested parties can access basic information about the association, clubs, age groups, where games are being played this weekend.

The system may be designed with a variety of access levels available to users to provide information to players, team managers and officials, club or association administrators and governing sporting bodies. The information may be tailored to suit the desires of the various user groups or to suit the type of information that the system provider desires to release.

The system may be adapted to provide at least one, some or all of the following capabilities:
Comprehensive guide to the services, facilities, competitions, history, clubs and teams within a sporting competition as well as contact information for all clubs,
Access to competition fixtures, results, venues and points ladders,
Links to club websites as well as links to National sites,
Access to rules and by-laws of the particular game, and
News and events notification.
Access to game reports with breakdown of results, scorers, etc,
Access to personal details such as address and contact information,
Personal statistics
Team Images
Club news and events
Reduced paperwork and increased convenience.
Access to team members contact details
Access to team members statistics
Access to administration forms etc
Access to a variety of team administration reports
Reduced match day paperwork,
Access to all of the club members contact details and statistics
Ability to add club news and events and/or electronic newsletter
Sponsorship opportunities on club pages
Data distribution saves time and cost of physical reproduction
Automatic collation of statistics
Increased efficiency including access at all times via the internet and reduction in paperwork and physical record keeping.
Real time collection of data including compilation, analysis and review
Opportunity cost with regard to useful time
Compilation of player histories
More convenient and useful access to information
Simplified distribution of data including reducing level of manual data distribution
A variety of styles and filters provides access to a variety of reports, and
System adapted to suit the requirements of individual associations.

### BRIEF DESCRIPTION OF THE DRAWINGS

Aspects of the present invention will now be described in relation to the accompanying drawings in which

FIG. 1 is a schematic diagram of the interrelated elements of the system.

FIG. 2 is a schematic site map for the related world wide computer network (or Web) site according to a preferred embodiment of the present invention.

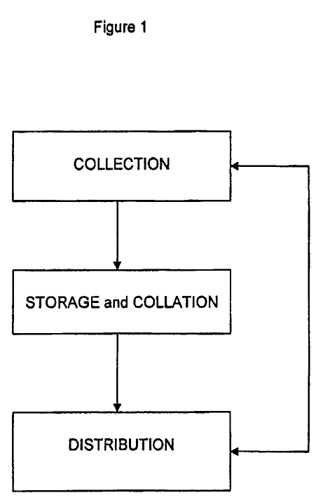

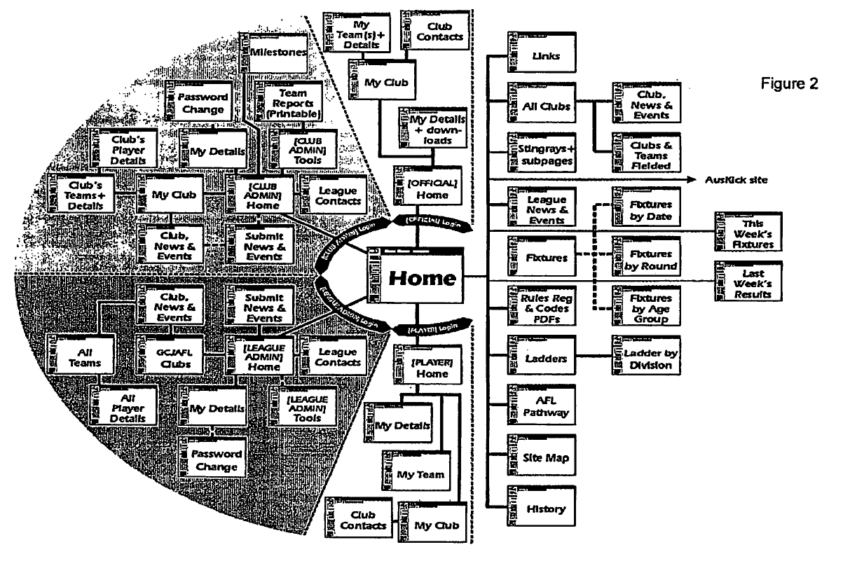

With respect to the FIG. 1, data collected can be on-forwarded to a data storage facility forwarded to a data distribution facility, in turn communicable to the data collection facility.

From the point of view of commercialising the system, a number of alternative user packages may be offered, for example:
A STANDARD PACKAGE, to include
   Data collection/storage and administration software
   Customised web site
   Digital Camera.
A STANDARD PLUS PACKAGE, to include
   Data collection/storage and administration software
   Customised web site
   Digital Camera
   Player ID cards
A DELUXE PACKAGE, to include
   Data collection/storage and administration software
   Customised web site
   Digital Camera
   On ground data collection facility
A DELUXE PLUS PACKAGE, to include
   Data collection/storage and administration software
   Customised web site
   Digital Camera
   Player ID cards
   On ground data collection facility.

The system has been designed as a complete administration package. The system provider benefits participants at all levels throughout the various associations. The system is designed with a variety of access levels that provide information to players, team managers and officials, club or association administrators and governing sporting bodies.

A brief outline of some of the benefits provided by the system to the various user groups is:
Public
   Comprehensive guide to the services, facilities, competitions, history, clubs and teams within a sporting competition as well as contact information for all clubs,
   Access to competition fixtures, results, venues and points ladders,
   Links to club websites as well as links to National sites,
   Access to rules and by-laws of the particular game, and
   News and events notification.
Players
   All of the above plus
   Access to game reports with breakdown of results, scorers, etc,
   Access to personal details such as address and contact information,
   Personal statistics
   Team Images
   Club news and events
Game and Team Officials
   All of the above plus,
   Access to team members contact details
   Access to team members statistics
   Access to administration forms etc
   Access to a variety of team administration reports
   Reduced match day paperwork.
Club Administrators
   All of the above plus
   Access to all of the club members contact details and statistics
   Ability to add club news and events and/or electronic newsletter
   Sponsorship opportunities on club pages
   Data distribution saves time and cost of physical reproduction
   Automatic collation of statistics
   Increased efficiency including access at all times via the internet and reduction in paperwork and physical record keeping.
Competition Administrators
   All of the above plus
   Real time collection of data including compilation, analysis and review
   Opportunity cost with regard to useful time
   Compilation of player histories
   More convenient and useful access to information
   Simplified distribution of data including reducing level of manual data distribution
   A variety of styles and filters provides access to a variety of reports, and
   System adapted to suit the requirements of individual associations.

Aspects of the present invention have been described by way of example only and modifications and additions thereto may be made without departing from the spirit or scope thereof.

1. An administration system to assist administrators of an event having multiple participants, the system adapted to allow a system administrator to collect analyse and distribute up to date information about at least one participant, the administration system comprising
a. a participant identification means issued to each participant, having at least one identifying feature of the participant recorded thereon;
b. at least one portable data collection means adapted to allow collection of information relating to each participant of the event, upon presentation of the participant identification means,
c. a remote data storage means associated with the at least one data processing unit to store at least a copy of all information collected by the data collection means, and
d. data distribution means adapted to allow access to the information contained in the data storage means.

2. The administration system according to claim 1 wherein the system operates on at least one computer having at least one controlling software application to control, maintain and update the information stored in the data storage means and the functions of the system.

3. The administration system according to claim 1 wherein the data collection means further includes a checklist procedure associated with each data processing unit, the checklist procedure being adapted to recognize the at least one identifying feature of each participant and to update the information stored on the data storage means accordingly.

4. The administration system according to claim 1 wherein the data processing unit is used remotely from the data storage means.

5. The administration system according to claim 1 wherein the data processing unit is adapted to communicate remotely with the data storage means.

6. The administration system according to claim 1 wherein the data processing unit is adapted to provide at least one notification of a predetermined situation occurring.

7. The administration system according to claim 1 wherein the data storage means comprises a network of computers.

8. The administration system according to claim 1 wherein the data storage means is adapted to collect, analyses collate or filter information stored therein and present the information for in a useable form.

9. The administration system according to claim 1 wherein the data processing unit stored the information collected at least temporarily.

10. The administration system according to claim 1 wherein the system operates in virtually instantaneously allowing real time updates.

11. The administration system according to claim 1 wherein the participant identification means includes a code recognisable by the data processing means, the code identifying a participant and allowing access to the participant's information stored on the data storage means.

12. The administration system according to claim 2 wherein the data processing means includes at least one software application compatible with the controlling software application to allow a user of the data processing means to access and filter information contained on the data storage unit.

13. The administration system according to claim 1 wherein the data distribution means is linked to the data storage means and is updateable therefrom.

14. The administration system according to claim 13 wherein the data distribution means is updated automatically at predetermined period from the data storage means.

15. The administration system according to claim 1 wherein a user is provided with one of a plurality of access levels each access level provided for security purposes and each access level granting access to information in response to parameters chosen by a user.

16. The administration system according to claim 15 wherein the access level of a user determines the type and extent of information accessible by that user.

17. The administration system according to claim 1 wherein the at least one data processing unit is adapted to collect information about each participant in order to allow the production and maintenance of records in an electronic form.

18. The administration system according to claim 17 wherein the information collected over a period of time is transferred to the data storage means at predetermined intervals and when transferred, updates the information stored in the data storage means.

19. The administration system according to claim 8 further including a reporting means for producing reports based on the information stored in the data storage means.

20. The administration system according to claim 13 wherein the data distribution means is adapted to receive and process requests for information from users and is adapted to analyse the information stored in the data storage means and to provide the requested information once the request for information has been processed.

21. The administration system according to claim 20 wherein a user is provided with one of a plurality of access levels each access level provided for security purposes and each access level granting access to information in response to parameters chosen by a user and processing the request includes checking that the user has access to the requested information.

22. The administration system according to claim 1 wherein the data processing means and the data storage means are both provided with access codes which are independent of each other.

23. The administration system according to claim 22 wherein more than one access code is provided for each of the data processing means and the data storage means.
